(19) United States
(12) Patent Application Publication
(10) Pub. No.: US 2006/0085566 A1
(43) Pub. Date: Apr. 20, 2006

(54) System with data bus and method for controlling operation thereof

(75) Inventor: Sang-hyong Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/210,675

(22) Filed: Aug. 25, 2005

(30) Foreign Application Priority Data
Oct. 15, 2004 (KR) 2004-82426

(51) Int. Cl. G06F 3/00

(52) U.S. Cl. 710/8

(57) ABSTRACT

A system with a data bus and a method for controlling operation thereof are provided. In the system with a data bus, a host controls primary functions of the overall system including the data bus, and an agent is connected to the data bus for performing additional functions of the overall system, wherein, upon power on, the agent downloads a firmware stored in the host via the data bus to perform the additional functions. Accordingly, it is possible to store a firmware needed to operate a network card in advance and then provide the firmware to the network card.

### CROSS-REFERENCE TO RELATED APPLICATIONS

This application claims the benefit under 35 U.S.C. § 119(a) from Korean Patent Application Serial No. 2004-82426, entitled “System with Data Bus and Method for Controlling Operation Thereof”, filed on Oct. 15, 2004, the entire content of which is herein incorporated by reference.

### BACKGROUND OF THE INVENTION

1. Field of the Invention

The present invention relates to a system with a data bus and a method for controlling operation thereof. More particularly, the present invention relates to a system with a data bus which stores in advance a firmware needed to operate network cards and then provides the firmware to the network cards, and a method for controlling operation of the system.

2. Description of the Related Art

In general, an image forming device, which forms an image on a sheet of paper, communicates with a peripheral device for exchanging data by using a peripheral component interconnect (PCI) bus. For example, when a network print card (NPC) as the peripheral device is mounted to the image forming device, the NPC receives external print data through a network and sends the received print data to the image forming device via the PCI bus.

Image forming devices with NPC mounted thereto are characterized by their information and operations which differ according to their design mechanisms, functions and the like. Accordingly, the NPC generally requires a suitable firmware for each image forming device.

In other words, a conventional peripheral device, which communicates with a conventional image forming device for exchanging data via a PCI bus, requires a devoted firmware for the image forming device to perform its particular functions. The firmware for each image forming device is stored in a memory area of each NPC.

Accordingly, when a user desires to use a peripheral device, which has been mounted to an image forming device A, in an image forming device B, it is necessary to upgrade a firmware stored in the peripheral device A with a firmware suitable for the image forming device B or purchase the peripheral device B having a firmware for the image forming device B.

Further, because a conventional peripheral device requires a separate memory for storing a firmware, it increases a manufacturing cost of the peripheral device.

### SUMMARY OF THE INVENTION

Accordingly, an object of the present invention is to provide a system using a data bus, which is capable of addressing the problems of an increasing manufacture cost due to requirement for a memory that stores firmwares, as well as inconvenience of manually upgrading firmwares of network cards which are differently implemented from product to product or purchasing a new network card according to a product, and a method for controlling the operation of the system.

The above object of the present invention is substantially realized by providing a system with a data bus comprising a host for controlling primary functions of the overall system comprising the data bus, and an agent connected to the data bus for performing additional functions of the overall system, wherein, upon power on, the agent downloads a firmware stored in the host via the data bus to perform the additional functions.

More specifically, the host may comprise a first memory for storing the firmware for the agent, and a control unit for enabling the firmware stored in the first memory to be provided to the agent via the data bus upon power on.

Further, the agent may comprise a temporary memory for temporarily storing the firmware downloaded via the data bus, a boot logic for initializing a bus interface and the temporary memory upon power on, and a central processing unit for performing its reset operation when the firmware stored in the first memory is stored in the temporary memory after the initialization by the boot logic is completed.

Preferably, the control unit may determine a type of the agent connected to the data bus and then enables a firmware corresponding to the determined agent to be provided to the temporary memory.

Here, the host may be an image forming device and the agent may be one of a local area network (LAN) card and a network print card.

Further, the data bus may be a peripheral component interconnect (PCI) bus, and the network card may be operated by the firmware provided by the main control unit.

In accordance with another aspect of the present invention, provided a method for controlling the operation of a system that uses a data bus is provided. The method comprises powering on the system, downloading a firmware stored in a host to an agent via the data bus, and performing, by the agent, additional functions based on the downloaded firmware.

Specifically, downloading may comprise determining a type of the agent connected to the data bus, and downloading the stored firmware corresponding to the determined agent to a temporary memory of the agent via the data bus.

Preferably, in performing the additional functions by the agent, a bus interface for providing a communication interface with the bus and the temporary memory for storing the firmware may be initialized upon power on, and reset operation may be performed when the firmware is stored in the temporary memory after the initialization is completed.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a schematic block diagram illustrating a system with a data bus according to an exemplary embodiment of the present invention;

FIG. 2 is a schematic flow diagram illustrating a method for controlling the operation of the system shown in FIG. 1 according to an exemplary embodiment of the present invention; and

FIG. 3 is a schematic flow diagram illustrating the operation of a first network card upon performing a step S200 shown in FIG. 2 according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, the present invention will be described in greater detail with reference to the accompanying drawings.

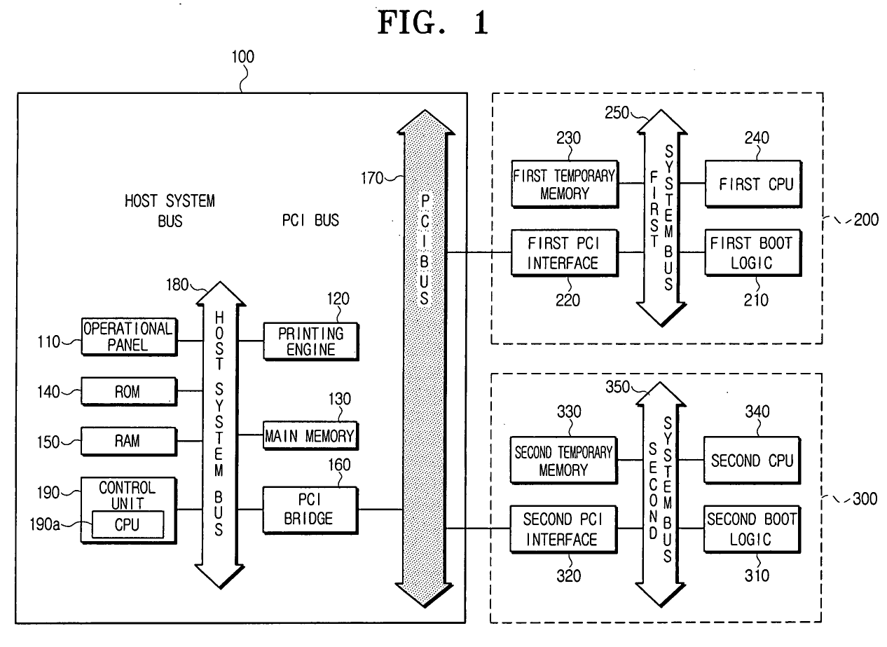

FIG. 1 is a schematic block diagram illustrating a system with a data bus according to an exemplary embodiment of the present invention;

Referring to FIG. 1, a system with a data bus according to an exemplary embodiment of the present invention comprises a host 100, a first agent 200 and a second agent 300.

The host 100 uses a peripheral component interconnect (PCI) bus 170 as a data bus. As an example, the host 100 is an image forming device.

The image forming device 100 comprises an operational panel 110, a printing engine 120, a main memory 130, a read only memory (ROM) 140, a random access memory (RAM) 150, a PCI bridge 160, a PCI bus 170, a host system bus 180 and a control unit 190.

The image forming device 100 shown in FIG. 1 performs a printing task and may be any device for forming an image on a sheet of paper, such as a printer, a facsimile, a scanner, a multi-function device or the like.

The image forming device 100 according to an exemplary embodiment of the present invention is connected to several host computers for performing network printing. The image forming device 100 is detachably equipped with at least one agent which is capable of supporting PCI interfacing. Examples of the agent which is capable of supporting PCI interfacing comprise network cards, such as a network print card (NPC), a local area network (LAN) card, a hard disk drive, and a sound card. In this example, the agent is described as a first network card 200, and a second network card 300.

The operational panel 110 comprises various function keys for selecting and setting function supported by the image forming device 100, and a liquid crystal display (LCD) window (not shown) for displaying the operation state of the image forming device 100.

The printing engine 120 prints document data received from an external device, such as a host computer (not shown). To perform the printing task, the printing engine 120 comprises a settlement unit (not shown) for heating and pressing a print paper having an image formed thereon at a predetermined temperature to settle the image on the print paper.

The main memory 130 stores firmwares for the number of network cards 200 and 300 connected to the PCI bus 170. The main memory 130 may be a Non-Volatile Random Access Memory (NVRAM) which may be NAND type or NOR type, a hard disk, or the like. The firmware is a program for enabling unique function of the network card to be operated and is designed in view of features of the image forming device 100.

The ROM 140 is a nonvolatile memory and stores a control program for controlling the overall operation of the image forming device 100.

The RAM 150 is a volatile memory and stores a loaded program from ROM 140 to be executed by the control of the control unit 190 or temporarily stores print data and the like produced in a printing task.

The PCI bridge 160 synchronizes a clock between the host system bus 180 and the PCI bus 170, and controls overall data transmission, such as data transmission between the network card, for example, the first network card 200 connected to the PCI bus 170 and the main memory 130.

The PCI bus 170 is communicably connected with at least one network card, for example, the first network card 200 which is detachably inserted into a slot (not shown) of the PCI bus 170.

The host system bus 180 provides a data or signal travel path among the operational panel 110, the printing engine 120, the main memory 130, ROM 140, RAM 150, and the control unit 190.

The control unit 190 controls the overall operation of the image forming device 100 according to the control program stored in the ROM 140. For example, the control unit 190 translates data to be printed which is received from a host computer (not shown) to a printable data, and then, controls the printing engine 120 to print the printable data.

In an exemplary embodiment of the present invention, the control unit 190 resets its CPU 190a when the image forming device 100 is powered on. The control unit 190 fetches execution codes from ROM 140 and initializes the PCI bus 170, and then, scans the PCI bus 170 to determine a number and type of network cards connected to the PCI bus 170. The control unit 190 retrieves ID recorded in a PCI configuration space in the respective network card to determine the number and type of the network cards.

When there are two network cards and the first network card 200 and the second network card 300 are connected to the PCI bus 170, the control unit 190 determines whether a first firmware corresponding to the first network card 200 is stored in the main memory 130.

If it is determined that the first firmware is stored in the main memory 130, the control unit 190 reads out the first firmware corresponding to the first network card 200 from the main memory 130 and provides it to the first network card 200. The first firmware is stored in a first temporary memory 230 via the PCI bridge 160, the PCI bus 170 and a first PCI interface 220.

After the first firmware is stored in the first temporary memory 230, the control unit 190 determines whether a second firmware corresponding to the second network card 300 is stored in the main memory 130. When the second firmware is stored in the main memory 130, the control unit 190 reads out the second firmware corresponding to the second network card 300 from the main memory 130 and provides it to the second network card 300. The second firmware is stored to a second temporary memory 330 via the PCI bridge 160, the PCI bus 170, and a second PCI interface 320.

When the firmwares corresponding to all the network cards connected to the PCI bus 170 are stored, the control unit 190 enters into a standby state, such as printing task standby.

Meanwhile, the first network card 200 comprises a first boot logic 210, the first PCI interface 220, the first temporary memory 230 and a first CPU 240. A first system bus 250 provides a data or signal travel path among the first boot logic 210, the first PCI interface 220, the first temporary memory 230 and the first CPU 240.

When the first network card 200 is connected to the PCI bus 170 and then is powered on, the first boot logic 210 activates the first PCI interface 220 and the first temporary memory 230 before the first CPU 240 operates. That is, the first boot logic 210 initiates the first PCI interface 220 and the first temporary memory 230 associated with the firmware of the first network card 200 before the first CPU 240 is reset. Here, the first boot logic 210 performs initialization by setting registers for the first PCI interface 220 and the first temporary memory 230 with set values stored in an electrically erasable and programmable read only memory (EEPROM) (not shown).

As the first PCI interface 220 and the first temporary memory 230 are activated, the image forming device 100 is able to gain access to the first temporary memory 230 via the PCI bus 170 and also able to provide the first firmware corresponding to the first network card 200 to the first temporary memory 230.

The first PCI interface 220 provides a communication interface with the PCI bus 170. That is, the first network card 200 is connected to the PCI bus 170 via the first PCI interface 220. This first PCI interface 220 has a first PCI configuration space (not shown) where the ID of the first network card 200 is stored.

The first temporary memory 230 is a volatile memory and temporarily stores the first firmware which is provided from the main memory 130 via the first PCI interface 220 after the first temporary memory 230 is initialized.

After the first boot logic 210 initializes the first PCI interface 220 and the first temporary memory 230, the first CPU 240 conducts its reset operation when the first firmware provided from the main memory 130 is stored in the first temporary memory 230 via the first PCI interface.

Upon power off, the first firmware stored in the first temporary memory 230 is erased.

The second network card 300 comprises a second boot logic 310, the second PCI interface 320, the second temporary memory 330, and a second CPU 340. The second system bus 350 provides a data or signal travel path between the second boot logic 310, the second PCI interface 320, the second temporary memory 330 and the second CPU 340.

Since the second boot logic 310, the second PCI interface 320, the second temporary memory 330 and the second CPU 340 perform similar operations to those of the first boot logic 210, the first PCI interface 220, the first temporary memory 230 and the first CPU 240, description thereof will be omitted. However, a second firmware from the main memory 130 corresponding to the second network card 300 is stored in the second temporary memory 330.

In one example, the first network card 200 may be NPC and the first firmware from the image forming device 100 corresponding to the NPC may be stored in the first temporary memory 230. When data to be printed is received from a host computer (not shown) which is communicably connected to the NPC, the first CPU 240 of the NPC operates the first firmware stored in the first temporary memory 230 to provide the data to be printed to the image forming device 100.

When the data to be printed is received via the first PCI interface 220, the PCI bus 170 and the PCI bridge 160, the control unit 190 translates the data to be printed to the printable data and controls the printing engine 120 to print the converted print data.

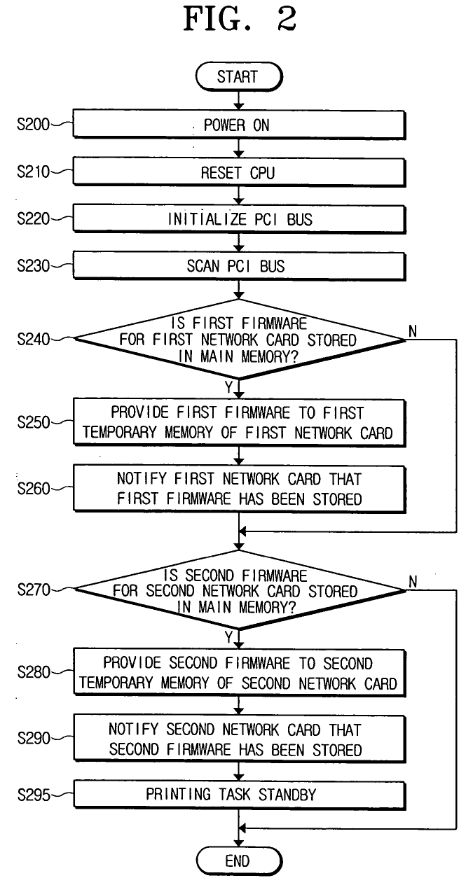

FIG. 2 is a schematic flowchart illustrating a method for controlling the operation of the system shown in FIG. 1 according to an exemplary embodiment of the present invention.

Referring to FIGS. 1 and 2, when the image forming device 100 is powered on, the control unit 190 resets CPU 190a so that CPU 190a operates at step S200 and step S210.

The control unit 190 then fetches execution codes from ROM 140 and initializes the PCI bus 170 at step S220.

The control unit 190 scans the PCI bus 170 to determine a number, type and the like of network cards connected to the PCI bus 170 at step S230.

For example, if it is determined in step S230 that the first network card 200 and the second network card 300 are connected to the PCI bus 170, the control unit 190 first determines whether the first firmware corresponding to the first network card 200 is stored in the main memory 130 at step S240.

If it is determined that the first firmware is stored in the main memory 130, the control unit 190 controls such that the first firmware of the main memory 130 corresponding to the first network card 200 can be stored in the first temporary memory 230 at step S250. When the first firmware is stored in step S250, the control unit 190 indicates the first network card 200 that the first firmware has been stored at step S260.

The control unit 190 then determines whether the second firmware corresponding to the second network card 300 is stored in the main memory 130 at step S270. If it is determined that the second firmware is stored, the control unit 190 stores the second firmware of the main memory 130 corresponding to the second network card 300 to the second temporary memory 330 at step S280.

The control unit 190 then enters a printing task standby state at step S290.

When the first network card 200 is a NPC and data to be printed is received from a host computer communicably connected to the NPC, the first CPU 240 of the NPC operates the first firmware stored in the first temporary memory 230 to provide the data to be printed to the image forming device 100. The control unit 190 translates the data to be printed, which is received from the NPC, to the printable data and controls the printing engine 120 to print the print data at step S295.

Meanwhile, when step S200 is performed, the first network card 200 and the second network card 300, connected to the PCI bus 170 also perform predetermined operations.

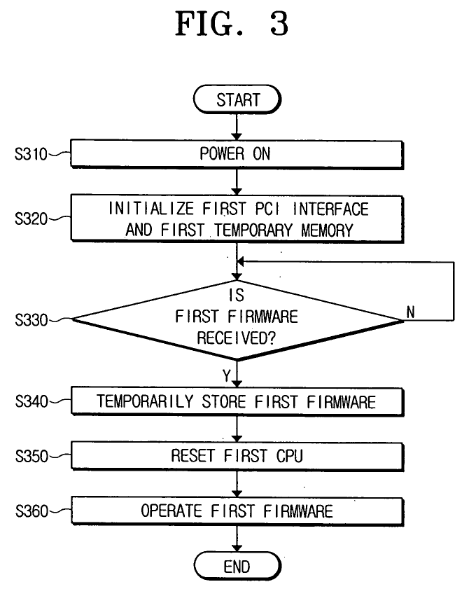

FIG. 3 is a schematic flowchart illustrating the operation of a first network card upon performing a step S200 shown in FIG. 2 according to an exemplary embodiment of the present invention.

Referring to FIGS. 1 through 3, upon power on, the first boot logic 210 initializes the first PCI interface 220 and the first temporary memory 230 before the first CPU 240 operates at step S310 and step S320.

The first network card 200 then waits to receive the first firmware needed to operate the first network card 200 from the image forming device 100 at step S330.

When the first firmware provided by the image forming device 100 is temporarily stored in the first temporary memory 230 according to S210 to S260, the first CPU 240 initiates its reset operation at steps S340 and S350.

The first CPU 240 then fetches execution codes of the first firmware stored in the first temporary memory 230 to operate the first firmware at step S360.

Here, the second network card 300 performs similar operations to those in FIG. 3 and the operation thereof will be omitted.

Meanwhile, although the image forming device 100 according to an exemplary embodiment of the present invention has been described as being the printer, any device having a PCI bus and a network card, such as a multi-function device, a facsimile, a scanner or the like, is also applicable.

Further, in the above-described the image forming device 100 according to the exemplary embodiment of the present invention, when the printing engine 120 is provided on a separate board, the separate board is connected to the PCI bus 170. In this case, by storing the firmware needed to operate the printing engine 120 in the image forming device 100, it is also possible to operate the printing engine 120 even though the printing engine 120 has no stored firmware.

Further, in the above-described exemplary embodiment of the present invention, when the firmware corresponding to the network card connected to the PCI bus 170 is not stored in the main memory 130, the image forming device 100 may indicate the user that the connected network card is unavailable. For example, by outputting an alarm sound at predetermined times or flickering an LED device at predetermined time interval, it is indicated to the user that the firmware corresponding to the connected network card is not stored and accordingly the network card is unavailable.

As described above, with the system having the data bus and the method for controlling the operation thereof according to the exemplary embodiments of the present invention, firmwares of peripheral devices connected to the PCI bus are stored in the image forming device in advance and then temporarily stored in the peripheral device each time the peripheral device is connected to the system. Accordingly, even when the peripheral device is mounted to different model of image forming apparatus, it is possible to perform normal operation without an upgrade of the firmware needed to operate the peripheral device.

Further, by storing a firmware suitable for an image forming device and a peripheral device in the image forming device in advance, it is unnecessary to separately produce and manage peripheral devices having the same hardware configuration for each version of the firmware, thereby management efficiency improves.

Further, it is unnecessary to mount a flash memory for storing firmwares to a peripheral device; thereby a manufacture cost of the peripheral device can be decreased.

The foregoing embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A system with a data bus comprising:
a host for controlling primary functions of the overall system comprising the data bus; and
an agent connected to the data bus for performing additional functions of the overall system, wherein, upon power on, the agent downloads a firmware stored in the host via the data bus to perform the additional functions.

2. The system as claimed in claim 1, wherein the host comprises:
a first memory for storing the firmware for the agent; and
a control unit for enabling the firmware stored in the first memory to be provided to the agent via the data bus upon power on.

3. The system as claimed in claim 2, wherein the agent comprises:
a temporary memory for temporarily storing the firmware downloaded via the data bus;
a boot logic for initializing a bus interface and the temporary memory upon power on; and
a central processing unit for performing a reset operation when the firmware in the first memory is stored in the temporary memory after the initialization by the boot logic is completed.

4. The system as claimed in claim 2, wherein the control unit determines a type of the agent connected to the data bus and provides a firmware corresponding to the determined agent to the temporary memory.

5. The system as claimed in claim 1, wherein the host is an image forming device and the agent is one of a local area network (LAN) card and a network print card.

6. The system as claimed in claim 1, wherein the data bus is a peripheral component interconnect (PCI) bus.

7. The system as claimed in claim 2, wherein the agent is a network card and the network card is operated by the firmware provided by the main control unit.

8. A method for controlling the operation of a system that uses a data bus, comprising:
powering on the system;
downloading a firmware stored in a host to an agent via the data bus; and
performing, by the agent, additional functions based on the downloaded firmware.

9. The method as claimed in claim 8, wherein the step of downloading comprises:
determining a type of the agent connected to the data bus; and
downloading the stored firmware corresponding to the determined agent to a temporary memory of the agent via the data bus.

10. The method as claimed in claim 9, wherein, in the step of performing the additional functions by the agent, a bus interface for providing a communication interface with the bus and the temporary memory for storing the firmware are initialized upon power on, and reset operation is performed when the firmware is stored in the temporary memory after the initialization is completed.

11. The method as claimed in claim 9, wherein the bus is a peripheral component interconnect (PCI) bus.

12. The method as claimed in claim 11, wherein the host is an image forming device and the agent is one of a local area network (LAN) card and a network print card.

13. The method as claimed in claim 9, wherein the agent is operated by the firmware in the temporary memory.
